(19) United States
(12) Patent Application Publication
(10) Pub. No.: US 2016/0223260 A1
(43) Pub. Date: Aug. 4, 2016

(54) HEATING FURNACE

(71) Applicants: Suehiro IWANE, Ikeda-shi, Osaka (JP); SHOEI MFG. CO., LTD., Osaka-shi, Osaka (JP)

(72) Inventors: Suehiro Iwane, Ikeda-shi, Osaka (JP); Tsuyoshi Kajitani, Osaka-shi, Osaka (JP)

(21) Appl. No.: 14/408,096

(22) PCT Filed: Jul. 30, 2013
(86) PCT No.: PCT/JP2013/070567

§ 371 Date: Dec. 15, 2014

(51) Int. Cl. F27B 17/00; F27B 9/36; F27B 9/10

(52) U.S. Cl. CPC F27B 17/0083; F27B 9/10; F27B 9/36

(57) ABSTRACT

A heating furnace includes a furnace body, a workpiece loading unit, a hearth, and a hot air supply device. The furnace body forms a furnace chamber. The furnace body has a workpiece passing opening. The workpiece loading unit is arranged inside the furnace chamber. The hearth rotates to allow the workpiece loading unit to rotate inside the furnace chamber. The hot air supply device is arranged inside a heating chamber. The hot air supply device sends out hot air into the furnace chamber. The heating furnace further includes a tubular partition. The tubular partition is arranged inside furnace chamber. The tubular partition divides the furnace chamber into an inner space and an outer space. The workpiece loading unit is arranged in the inner space.

### TECHNICAL FIELD

The present invention relates to a heating furnace.

### BACKGROUND ART

Patent Document 1 discloses a heat treatment furnace. The heat treatment furnace includes a furnace body opening downward and a floor body closing the lower opening of the furnace body. The furnace body and the floor body form a furnace chamber. Shelves are provided in the furnace chamber. Workpieces are mounted on the shelves. Hot air circulation devices are disposed on the outer periphery of the furnace body at two positions along the circumferential direction. The hot air circulation devices horizontally send hot air into the furnace chamber. Each of the hot air circulation devices communicates with the inside of the furnace chamber. Each of the hot air circulation devices has an opening. The opening faces the workpieces inside the furnace chamber. The hot air fed into the furnace chamber from each of the hot air circulation devices is circulated in the circumferential direction in the furnace chamber between the hot air circulation devices. A sand discharge mechanism is disposed on the floor body. The sand discharge mechanism discharges sand falling from the workpieces in the furnace chamber to the outside of the furnace chamber. The heat treatment furnace described in Patent Document 1 makes it possible to reduce variation in quality between workpieces. The heat treatment furnace also makes it possible to reduce the loss of energy. The heat treatment furnace also makes it possible to shorten the time required for the whole heat treatment including a soaking time. The heat treatment furnace achieves elongation of the durability thereof.

### PRIOR ART DOCUMENT

### Patent Document

Patent Document 1: Japanese Patent Application Laid-open No. 2006-200823

### SUMMARY OF THE INVENTION

### Problems to be Solved by the Invention

However, disadvantageously, the heat treatment furnace disclosed in Patent Document 1 fails to sufficiently reduce variation in temperature among various points inside the furnace chamber. That is, in the heat treatment furnace disclosed in Patent Document 1, temperatures often largely differ from each other among various points inside the furnace.

The present invention solves such a problem. An object of the present invention is to provide a heating furnace that reduces variation in temperature among various points inside a furnace chamber.

### Solutions to the Problems

A heating furnace of the present invention will be described with reference to drawings. In this column, reference signs in the drawings are used in description for the purpose of facilitating understanding of the contents of the invention. Thus, there is no intention to limit the contents to the illustrated range.

In order to solve the above problem, according to an aspect of the present invention, the heating furnace includes a furnace body 10, a workpiece loading unit 12, a hearth 14, and hot air supply devices 20, 24. The furnace body 10 forms a furnace chamber 40. The furnace body 10 has workpiece passing openings 70, 72, 74, 76. The workpiece loading unit 12 is arranged inside the furnace chamber 40. The hearth 14 faces the furnace chamber 40. The workpiece loading unit 12 is placed on the hearth 14. The hearth 14 rotates to allow the workpiece loading unit 12 to rotate inside the furnace chamber 40. The hot air supply devices 20, 24 are arranged inside the furnace chamber 40. The hot air supply devices 20, 24 send out hot air inside the furnace chamber 40. Tubular partitions 28 are arranged inside the furnace chamber 40. The tubular partitions 28 divide the furnace chamber 40 into an inner space 110 and an outer space 112. The workpiece loading unit 12 is arranged in the inner space 110. The hot air supply devices 20, 24 are arranged in the outer space 112. Each of the tubular partitions 28 has a furnace chamber inside communication portion 130 and a furnace outside communication portions 132 or 134. The furnace chamber inside communication portion 130 allows the inner space 110 and the outer space 112 to communicate with each other. The furnace outside communication portions 132, 134 allow the inner space 110 and the workpiece passing openings 70, 72, 74, 76 to communicate with each other.

Workpieces 200 are placed on the workpiece loading unit 12 through the workpiece passing openings 70, 72, 74, 76, and the furnace outside communication portions 132, 134. The workpiece loading unit 12 rotates inside the furnace chamber 40. Along with the rotation of the workpiece loading unit 12, the workpieces 200 also rotate inside the furnace chamber 40. While the workpieces 200 are rotating inside the furnace chamber 40, the hot air supply devices 20, 24 send out hot air inside the furnace chamber 40. The hot air flows to the inner space 110 through the furnace chamber inside communication portion 130 while flowing in the outer space 112. Even when hot air that has previously flown into the inner space 110 loses its thermal energy by heating the workpieces 200, hot air flowing into the inner space 110 thereafter compensates the lost thermal energy. Since the lost thermal energy is compensated, it is possible to reduce variation in temperature among various points inside the furnace chamber.

The above-described furnace chamber 40 desirably includes heat treatment chambers 46, 48, heating chambers 50, 52, and furnace chamber communication portions 54, 56. The workpiece loading unit 12 and the tubular partitions 28 are arranged in the heat treatment chambers 46, 48. The hot air supply devices 20, 24 are arranged in the heating chambers 50, 52. The furnace chamber communication portions 54, 56 allow the heating chambers 50, 52 and heat treatment chambers 46, 48 to communicate with each other. Hot air passes through the furnace chamber communication portions 54, 56. In this case, the furnace chamber inside communication portion 130 of each of the tubular partitions 28 desirably includes a hot air inflow portion 140 and a hot air replenishment portion 142. The hot air inflow portion 140 faces the furnace chamber communication portion 54 or 56. The hot air inflow portion 140 allows the inner space 110 and the outer space 112 to communicate with each other. The hot air replenishment portion 142 is arranged on the downstream side of the flow of hot air with respect to the hot air inflow portion 140. The hot air replenishment portion 142 allows the inner space 110 and the outer space 112 to communicate with each other.

The hot air inflow portion 140 faces the furnace chamber communication portions 54 or 56. Thus, a part of the hot air that has flown into the furnace chamber 40 directly flows into the inner space 110. The thermal energy of the hot air is used for heating an article inside the inner space 110. The other part of the hot air temporarily flows to the outer space 112, and then flows into the inner space 110 through the hot air replenishment portion 142. The hot air compensates the thermal energy in the inner space 110. Accordingly, it is possible to reduce the loss of thermal energy caused by transfer of thermal energy of hot air to the furnace body 10.

Alternatively, the above-described hot air replenishment portion 142 desirably includes an upstream opening portion 150 and a downstream opening portion 152. The upstream opening portion 150 has a hole 158. The hole 158 allows the inner space 110 and the outer space 112 to communicate with each other. The downstream opening portion 152 is arranged on the downstream side of the flow of hot air with respect to the upstream opening portion 150. The downstream portion 152 has a hole 158. The hole 158 allows the inner space 110 and the outer space 112 to communicate with each other. The opening area per unit area of the downstream opening portion 152 is larger than the opening area per unit area of the upstream opening portion 150.

Since the opening area per unit area of the downstream opening portion 152 is larger than the opening area per unit area of the upstream opening portion 150, a larger amount of hot air flows into the inner space 110 in the downstream opening portion 152 than the upstream opening portion 150. Hot air is prevented from flowing into the inner space 110 on the upstream side of the flow of hot air. Therefore, it is possible to prevent the temperature of the workpiece 200 from unnecessarily increasing.

Alternatively, the above-described tubular partition 28 desirably further includes a hot air outflow portion 136. The hot air outflow portion 136 is arranged on the downstream side of the flow of hot air with respect to the hot air replenishment portion 142. The hot air outflow portion 136 faces the furnace chamber communication portion 54 or 56 together with the hot air inflow portion 140. Hot air inside the inner space 110 flows out toward the furnace chamber communication portion 54 or 56 through the hot air outflow portion 136. In this case, the heating furnace further includes heating devices 22, 26. The heating devices 22, 26 are arranged inside the heating chambers 50, 52. Each of the heating devices 22, 26 heats hot air that has flown out through the hot air outflow portion 136 and then flown into each of the heating chambers 50, 52.

The hot air that has flown out through the hot air outflow portion 136 can be reused by heating hot air flown into the heating chambers 50, 52 by the heating devices 22, 26 and sending out the hot air into the furnace chamber 40 by the hot air supply devices 20, 24. Accordingly, it is possible to more efficiently use the thermal energy for heating the workpiece 200 than when thermal energy is not reused.

Alternatively, the above-described tubular partition 28 desirably further includes a hot air guide portion 138. The hot air guide portion 138 guides hot air fed into the heat treatment chamber 46 or 48 from the heating chamber 50 or 52 to the hot air inflow portion 140. The hot air guide portion 138 guides hot air flowing out through the hot air outflow portion 136 to the heating chamber 50 or 52.

The hot air guide portion 138 of the tubular partition 28 prevents hot air fed into the furnace chamber 40 and hot air guided to the heating chamber 50 or 52 from slowing their flow velocities each other. As a result, hot air more smoothly flows than when the hot air guide portion 138 is not provided.

Further, the above-described heating furnace desirably further includes a flow end wall 34. The flow end wall 34 is arranged between the inner peripheral surface of the furnace chamber 40 and the tubular partition 28. The flow end wall 34 blocks hot air.

Since the flow end wall 34 blocks hot air, the hot air totally flows into the inner space 110 before reaching the flow end wall 34. When the hot air totally flows into the inner space 110, the velocity of flow of hot air inside the inner space 110 becomes higher than when hot air does not totally flow into the inner space 110. The increase in the velocity of flow results in an increase in the heat transfer coefficient of hot air in a place where the velocity of flow increases. Further, the increase in the heat transfer coefficient makes it possible to efficiently compensate thermal energy.

Further, the above-described flow end wall 34 is desirably arranged on the downstream side of the flow of hot air with respect to the furnace outside communication portions 132, 134. In this case, the workpiece loading unit 12 rotates in a direction of the flow of hot air.

When the flow end wall 34 is arranged on the downstream side of the flow of hot air with respect to the furnace outside communication portions 132, 134, rise in the temperature of the workpiece 200 placed on the workpiece loading unit 12 through the workpiece passing openings 70, 72, 74, 76 and the furnace outside communication portions 132, 134 is accelerated.

The above-described heating furnace desirably further includes passage forming tubes 30, 32. The passage forming tubes 30, 32 are arranged between the furnace outside communication portions 132, 134 and the workpiece passing openings 70, 72, 74, 76. The passage forming tubes 30, 32 form passages.

When the passage forming tubes 30, 32 are arranged between the furnace outside communication portions 132, 134 and the workpiece passing openings 70, 72, 74, 76, it is possible to reduce the amount of hot air flowing through the outer space 112 and then flowing out of the furnace body 10 through the workpiece passing openings 70, 72, 74, 76. The reduction in the amount of hot air makes it possible to reduce the loss of thermal energy caused by hot air flowing out of the furnace.

The above-described workpiece loading unit 12 desirably includes shelves 80, 84 and direction guide bodies 86, 88. The direction guide bodies 86, 88 are arranged at the position nearer the rotation center of the hearth 14 than the shelves 80, 84. The direction guide bodies 86, 88 guide the flow of hot air in the inner space 110 to the rotation direction of the hearth 14.

Since the flow of hot air is guided to the rotation direction of the hearth 14, the hot air heats the workpiece 200 while flowing in the inner space 110. Accordingly, it is possible to efficiently transfer thermal energy to the workpiece 200 from the hot air.

### Effect of the Invention

As described above, according to the heating furnace of the present invention, it is possible to reduce variation in temperature between various points inside the furnace chamber.

### BRIEF DESCRIPTION OF THE DRAWINGS

FIG. 1 is a plan view of a heating furnace according to an embodiment of the present invention.

FIG. 2 is a cross-sectional view taken along line A-A of FIG. 1.

FIG. 3 is a cross-sectional view of a furnace body according to an embodiment of the present invention.

FIG. 4 is a cross-sectional view taken along line B-B of FIG. 2.

FIG. 5 is a cross-sectional view of a workpiece loading unit according to an embodiment of the present invention.

FIG. 6 is a perspective view of a tubular partition according to an embodiment of the present invention.

FIG. 7 is a cross-sectional view taken along line C-C of FIG. 1.

FIG. 8 is a conceptual diagram illustrating the tubular partition with inlet passage forming tubes and outlet passage forming tubes attached thereto according to an embodiment of the present invention.

### EMBODIMENT OF THE INVENTION

Hereinbelow, an embodiment of the present invention will be described with reference to the drawings. In the following description, identical components are designated by identical reference signs. The identical components have identical names and functions. Thus, detailed description thereof will not be repeated.

### [Configuration of Heating Furnace]

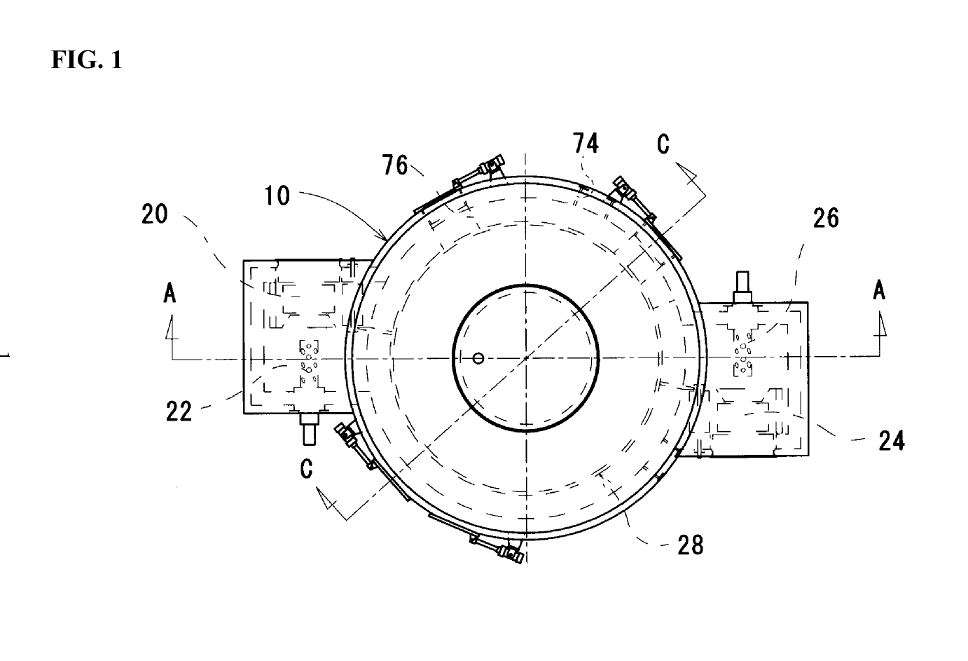

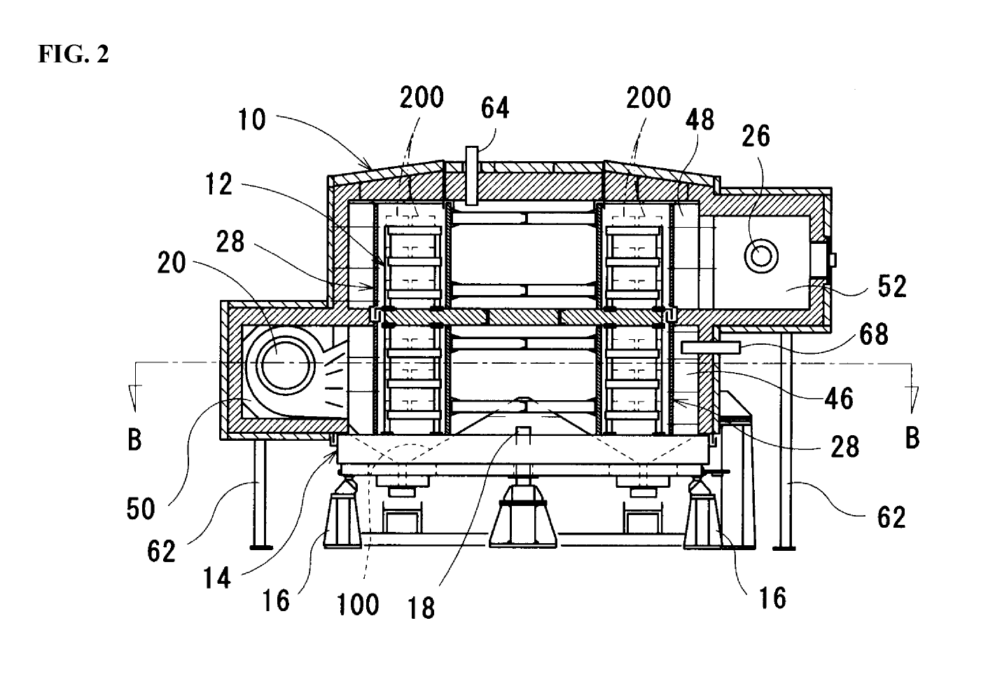

The configuration of a heating furnace according to the present embodiment will be described with reference to FIGS. 1 and 2. The heating furnace according to the present embodiment is provided with a furnace body 10, a workpiece loading unit 12, a hearth 14, a hearth supporting unit 16, a hearth rotating unit 18, a lower hot air supply device 20, a lower heating device 22, an upper hot air supply device 24, an upper heating device 26, and a tubular partition 28.

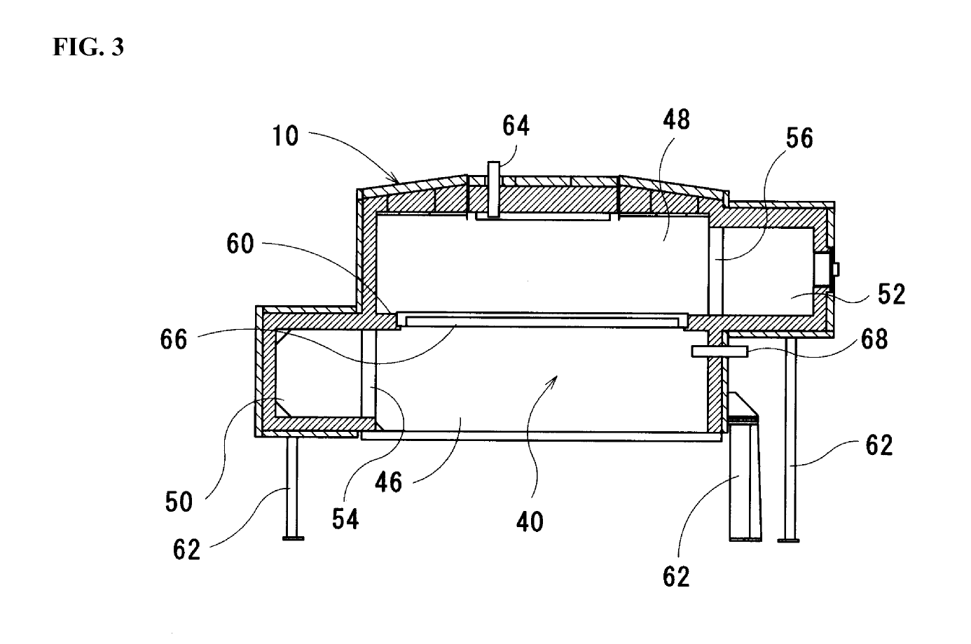

The configuration of the furnace body 10 according to the present embodiment will be described with reference to FIG. 3. The furnace body 10 forms a furnace chamber 40. The furnace chamber 40 is divided into a lower heat treatment chamber 46, an upper heat treatment chamber 48, a lower heating chamber 50, an upper heating chamber 52, a lower furnace chamber communication portion 54, and an upper furnace chamber communication portion 56. In the present embodiment, the lower heat treatment chamber 46 is a space in which a solution treatment which is a type of heat treatment is performed. The upper heat treatment chamber 48 is a space in which an aging treatment which is a type of heat treatment is performed. The lower heating chamber 50 is a space in which gas is heated. The lower hot air supply device 20 and the lower heating device 22 are arranged in the lower heating chamber 50. Also, the upper heating chamber 52 is a space in which gas is heated. The upper hot air supply device 24 and the upper heating device 26 are arranged in the upper heating chamber 52. The lower furnace chamber communication portion 54 allows the lower heating chamber 50 and the lower heat treatment chamber 46 to communicate with each other. Hot air passes through the lower furnace chamber communication portion 54. The upper furnace chamber communication portion 56 allows the upper heating chamber 52 and the upper heat treatment chamber 48 to communicate with each other. Hot air passes through the upper furnace chamber communication portion 56.

The furnace body 10 includes an annular partition 60, a furnace body supporting leg 62, an exhaust tube 64, a sand seal portion 66, and an exhaust tube 68. The annular partition 60 divides the lower heat treatment chamber 46 and the upper heat treatment chamber 48. The furnace body supporting leg 62 supports the entire furnace body 10. The exhaust tube 64 discharges a part of the gas inside the upper heat treatment chamber 48 therethrough. The sand seal portion 66 is disposed on the inner peripheral surface of the annular partition 60. Known sand is stored inside the sand seal portion 66. The exhaust tube 68 discharges a part of the gas inside the lower heat treatment chamber 46 therethrough.

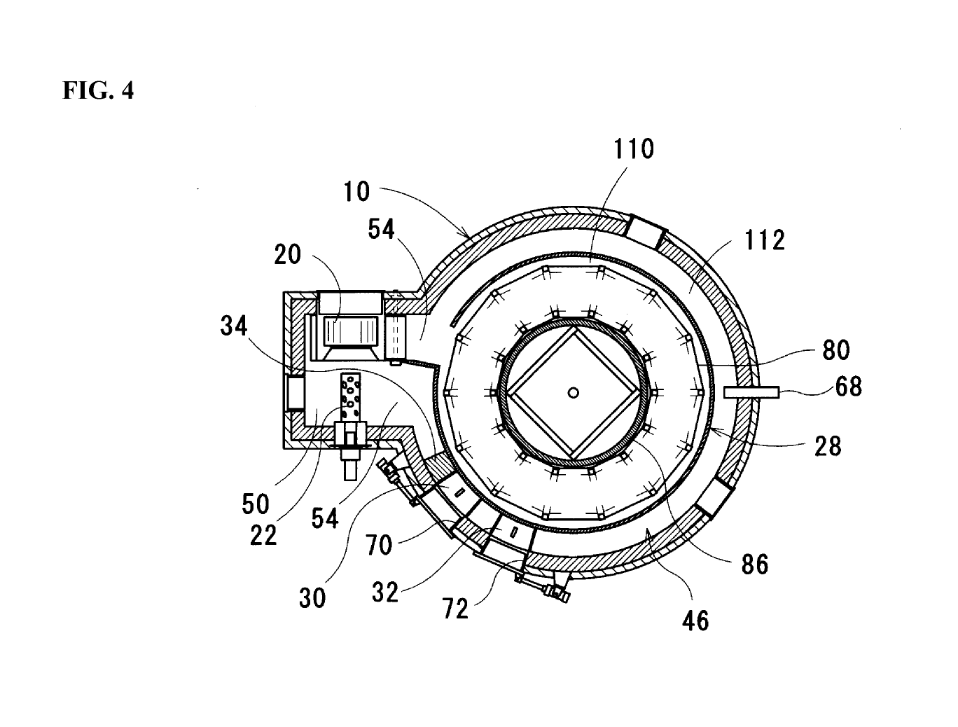

Workpiece passing openings according to the present embodiment will be described with reference to FIGS. 1 and 4. As illustrated in FIG. 4, the furnace body 10 has lower inlet openings 70 and lower outlet openings 72. As illustrated in FIG. 1, the furnace body 10 further has upper inlet openings 74 and upper outlet openings 76. In the present embodiment, the lower inlet openings 70, the lower outlet openings 72, the upper inlet openings 74, and the upper outlet openings 76 are collectively referred to as “workpiece passing openings”. The lower inlet openings 70 and the lower outlet openings 72 allow the lower heat treatment chamber 46 and the outside of the furnace body 10 to communicate with each other. The upper inlet openings 74 and the upper outlet openings 76 allow the upper heat treatment chamber 48 and the outside of the furnace body 10 to communicate with each other. Doors are attached to the respective workpiece passing openings. The number of workpiece passing openings is set to any number by a designer of the heating furnace according to the present embodiment.

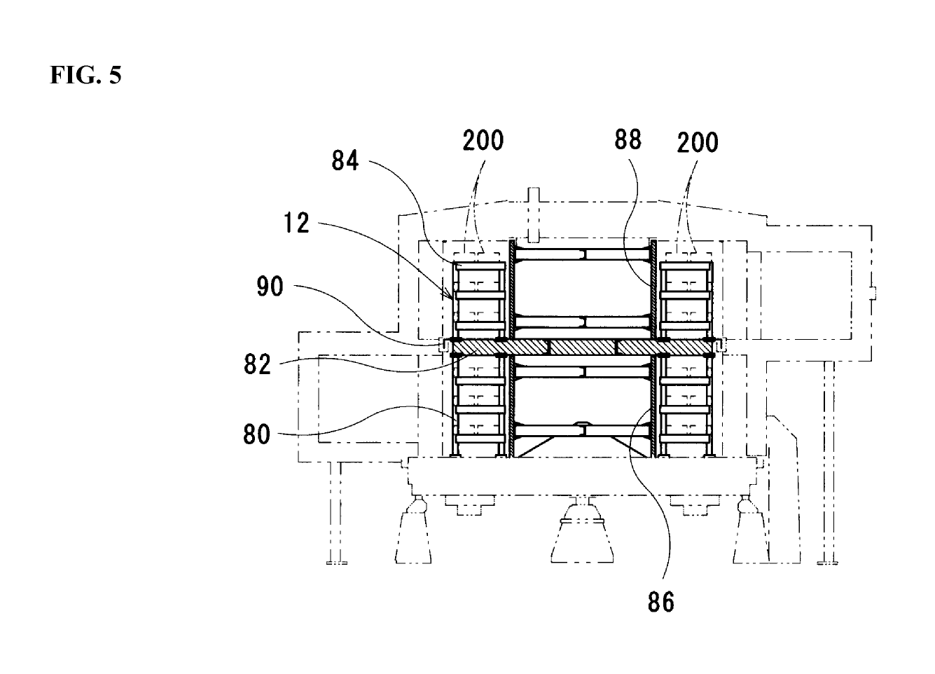

The configuration of the workpiece loading unit 12 according to the present embodiment will be described with reference to FIG. 5. The workpiece loading unit 12 is arranged inside the furnace chamber 40. The workpiece loading unit 12 includes a lower shelf 80, a partition plate 82, an upper shelf 84, a lower direction guide body 86, and an upper direction guide body 88. The lower shelf 80 is placed on the hearth 14. The lower shelf 80 and the hearth 14 are fixed to each other. The lower shelf 80 is arranged inside the lower heat treatment chamber 46 of the furnace chamber 40. A workpiece 200 is placed on the lower shelf 80. The partition plate 82 is placed on the lower shelf 80. The partition plate 82 and the lower shelf 80 are fixed to each other. A partition ring 90 is disposed on the outer periphery of the partition plate 82. The partition ring 90 is fitted into the sand seal portion 66 of the annular partition 60. As described above, sand is stored in the sand seal portion 66. This prevents heat transfer from the lower heat treatment chamber 46 to the upper heat treatment chamber 48. The upper shelf 84 is placed on the partition plate 82. The upper shelf 84 and the partition plate 82 are fixed to each other. The upper shelf 84 is arranged inside the upper heat treatment chamber 48 of the furnace chamber 40. A workpiece 200 is also placed on the upper shelf 84. The lower direction guide body 86 is fixed to the hearth 14 together with the lower shelf 80. The lower direction guide body 86 is arranged at the position nearer the rotation center of the heath 14 than the lower shelf 80. The upper direction guide body 88 is placed on the partition plate 82 together with the upper shelf 84. The upper direction guide body 88 is also fixed to the partition plate 82. The upper direction guide body 88 is arranged at the position nearer the rotation center of the hearth 14 than the upper shelf 84. In the present embodiment, the lower shelf 80 and the upper shelf 84 are collectively referred to as “shelves”. Further, the lower direction guide body 86 and the upper direction guide body 88 are collectively referred to as “direction guide bodies”.

The configuration of the hearth 14 according to the present embodiment will be described with reference to FIG. 2. The hearth 14 is arranged under the furnace body 10. The furnace body 10 has an opening formed on the lower end thereof. The hearth 14 is arranged to close the opening. The hearth 14 faces the furnace chamber 40. The workpiece loading unit 12 is placed on the hearth 14. The hearth 14 has a sand hopper 100. The sand hopper 100 is arranged right under the workpiece loading unit 12. Sand falling from the workpiece 200 is accumulated on the sand hopper 100. The accumulated sand is discharged to the lower side of the hearth 14.

The hearth supporting unit 16 and the hearth rotating unit 18 according to the present embodiment will be described with reference to FIG. 2. The hearth supporting unit 16 supports the hearth 14. A roller is disposed on the tip of the hearth supporting unit 16. The heart 14 is placed on the roller. The hearth rotating unit 18 penetrates the center of the hearth 14. The hearth rotating unit 18 drives the hearth 14 to allow the hearth 14 to rotate around the hearth rotating unit 18. Accordingly, the hearth 14 rotates around the hearth rotating unit 18. Since the workpiece loading unit 12 is placed on the hearth 14, the workpiece loading unit 12 rotates inside the furnace chamber 40 along with the rotation of the hearth 14.

The lower hot air supply device 20, the lower heating device 22, the upper hot air supply device 24, and the upper heating device 26 according to the present embodiment will be described with reference to FIGS. 1 and 2. The lower hot air supply device 20 is arranged inside the lower heating chamber 50 of the furnace body 10. The lower hot air supply device 20 sends out hot air into the lower heat treatment chamber 46. The hot air that has circulated inside the lower heat treatment chamber 46 again flows into the lower heating chamber 50. In the present embodiment, the lower hot air supply device 20 is composed of a sirocco fan. The sirocco fan sucks gas and sends out hot air to the lower heat treatment chamber 46. The lower heating device 22 is also arranged inside the lower heating chamber 50. The lower heating device 22 is arranged to face a gas suction port of the lower hot air supply device 20. The lower heating device 22 heats the hot air that has again flown into the lower heating chamber 50 from the lower heat treatment chamber 46. In the present embodiment, the lower heating device 22 is composed of a combustion burner. The upper hot air supply device 24 is arranged inside the upper heating chamber 52 of the furnace body 10. The upper hot air supply device 24 sends out hot air into the upper heat treatment chamber 48. The hot air that has circulated inside the upper heat treatment chamber 48 again flows into the upper heating chamber 52. In the present embodiment, the upper hot air supply device 24 is composed of a sirocco fan having the same structure as the lower hot air supply device 20. The upper heating device 26 is also arranged inside the upper heating chamber 52. The upper heating device 26 is arranged to face a gas suction port of the upper hot air supply device 24. The upper heating device 26 heats the hot air that has again flown into the upper heating chamber 52 from the upper heat treatment chamber 48. In the present embodiment, the upper heating device 26 is composed of a combustion burner having the same structure as the lower heating device 22.

The arrangement and function of the tubular partition 28 according to the present embodiment will be described with reference to FIG. 4. The tubular partition 28 is arranged in the lower heat treatment chamber 46. The tubular partition 28 arranged in the lower heat treatment chamber 46 divides a part of the furnace chamber 40 from the lower heating chamber 50 through the lower heat treatment chamber 46 into an inner space 110 and an outer space 112. The inner space 110 is located inside the tubular partition 28. The lower shelf 80 of the workpiece loading unit 12 is arranged in the inner space 110. Accordingly, the tubular partition 28 arranged in the lower heat treatment chamber 46 surrounds the lower shelf 80. The outer space 112 is located outside the tubular partition 28 in the furnace chamber 40. Thus, the lower heating chamber 50 is a part of the outer space 112.

A tubular partition having the same structure as the tubular partition arranged in the lower heat treatment chamber 46 is arranged in the upper heat treatment chamber 48. However, in the tubular partition arranged in the upper heat treatment chamber 48, the positions of furnace outside communication portions (described below) differs from that in the tubular partition arranged in the lower heat treatment chamber 46 in order to allow the furnace outside communication portions to face the upper inlet opening 74 and the upper outlet opening 76. The tubular partition 28 arranged in the upper heat treatment chamber 48 also divides a part of the furnace chamber 40 from the upper heating chamber 52 through the upper heat treatment chamber 48 into an inner space and an outer space. The upper shelf 84 of the workpiece loading unit 12 is arranged inside the inner space. Accordingly, the tubular partition 28 arranged in the upper heat treatment chamber 48 surrounds the lower shelf 80.

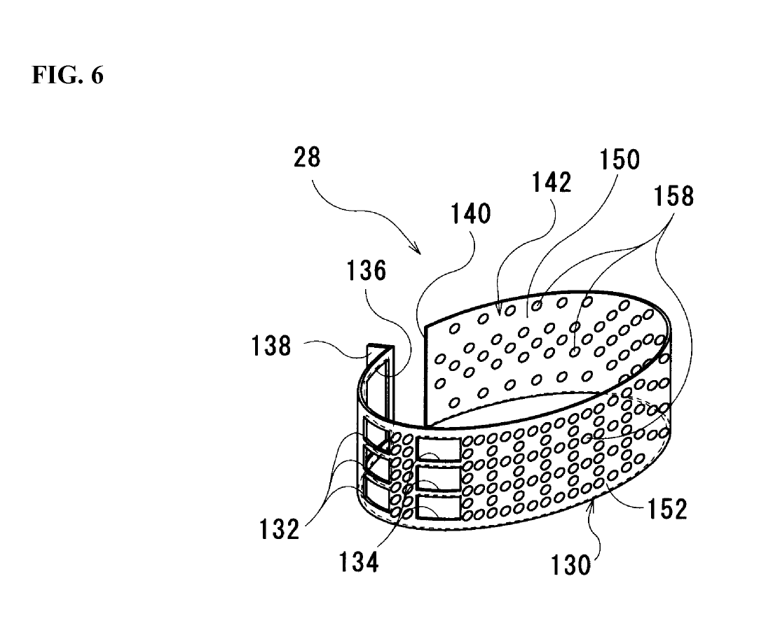

The configuration of the tubular partition 28 arranged in the lower heat treatment chamber 46 according to the present embodiment will be described with reference to FIG. 6. As described above, the tubular partition 28 arranged in the upper heat treatment chamber 48 has the same configuration as the tubular partition 28 arranged in the lower heat treatment chamber 46 excepting the positions of the furnace outside communication portions. In the present embodiment, the tubular partition 28 has a hollow cylindrical shape.

The tubular partition 28 includes a furnace chamber inside communication portion 130, furnace outside communication inlet portions 132, furnace outside communication outlet portions 134, a hot air outflow portion 136, and a hot air guide portion 138.

The furnace chamber inside communication portion 130 allows the inner space and the outer space to communicate with each other. In the following description, “inner space” refers to a space surrounded by the tubular partition 28 in the lower heat treatment chamber 46 when the tubular partition 28 is arranged in the lower heat treatment chamber 46 and refers to a space surrounded by the tubular partition 28 in the upper heat treatment chamber 48 when the tubular partition 28 is arranged in the upper heat treatment chamber 48. In the following description, “outer space” refers to a space located from the lower heating chamber 50 through the lower heat treatment chamber 46 as well as outside the tubular partition 28 in the furnace chamber 40 when the tubular partition 28 is arranged in the lower heat treatment chamber 46 and refers to a space located from the upper heating chamber 52 through the upper heat treatment chamber 48 as well as outside the tubular partition 28 in the furnace chamber 40 when the tubular partition 28 is arranged in the upper heat treatment chamber 48.

The furnace chamber inside communication portion 130 includes a hot air inflow portion 140 and the hot air replenishment portion 142. The hot air inflow portion 140 faces the furnace chamber communication portion. In this paragraph, “furnace chamber communication portion” refers to the lower furnace chamber communication portion 54 when the tubular partition 28 is arranged in the lower heat treatment chamber 46 and refers to the upper furnace chamber communication portion 56 when the tubular partition 28 is arranged in the upper heat treatment chamber 48. The hot air inflow portion 140 allows the inner space and the outer space to communicate with each other. The hot air replenishment portion 142 is arranged on the downstream side of the flow of hot air with respect to the hot air inflow portion 140. The hot air replenishment portion 142 allows the inner space and the outer space to communicate with each other.

The hot air replenishment portion 142 has an upstream opening portion 150 and a downstream opening portion 152. Holes 158 are formed on the upstream opening portion 150. The holes 158 allow the inner space and the outer space to communicate with each other. The downstream opening portion 152 is arranged on the downstream side of the flow of hot air with respect to the upstream opening portion 150. Holes 158 are also formed on the downstream opening portion 152. The opening area per unit area of the lower opening portion 152 by the holes 158 is larger than the opening area per unit area of the upstream opening portion 150 by the holes 158.

The furnace outside communication inlet portions 132 and the furnace outside communication outlet portions 134 allow the inner space and the workpiece passing openings to communicate with each other. That is, each of the lower inlet openings 70 communicates with the inner space through either one of the furnace outside communication inlet portions 132. Further, each of the lower outlet openings 72 communicates with the inner space through either one of the furnace outside communication outlet portions 134. The same applies to the upper inlet openings 74 and the upper outlet openings 76. In the present embodiment, the furnace outside communication inlet portions 132 and the furnace outside communication outlet portions 134 are collectively referred to as “furnace outside communication portions”.

The hot air outflow portion 136 is arranged on the downstream side of the flow of hot air with respect to the hot air replenishment portion 142. The hot air outflow portion 136 faces the furnace chamber communication portion together with the hot air inflow portion 140. Hot air inside the inner space flows out through the hot air outflow portion 136.

The hot air guide portion 138 guides hot air fed into the furnace chamber 40 from the heating chamber to the hot air inflow portion 140. The hot air guide portion 138 guides hot air flowing out through the hot air outflow portion 136 to the heating chamber. In this paragraph, “heating chamber” refers to the lower heating chamber 50 when the tubular partition 28 is arranged in the lower heat treatment chamber 46 and refers to the upper heating chamber 52 when the tubular partition 28 is arranged in the upper heat treatment chamber 48.

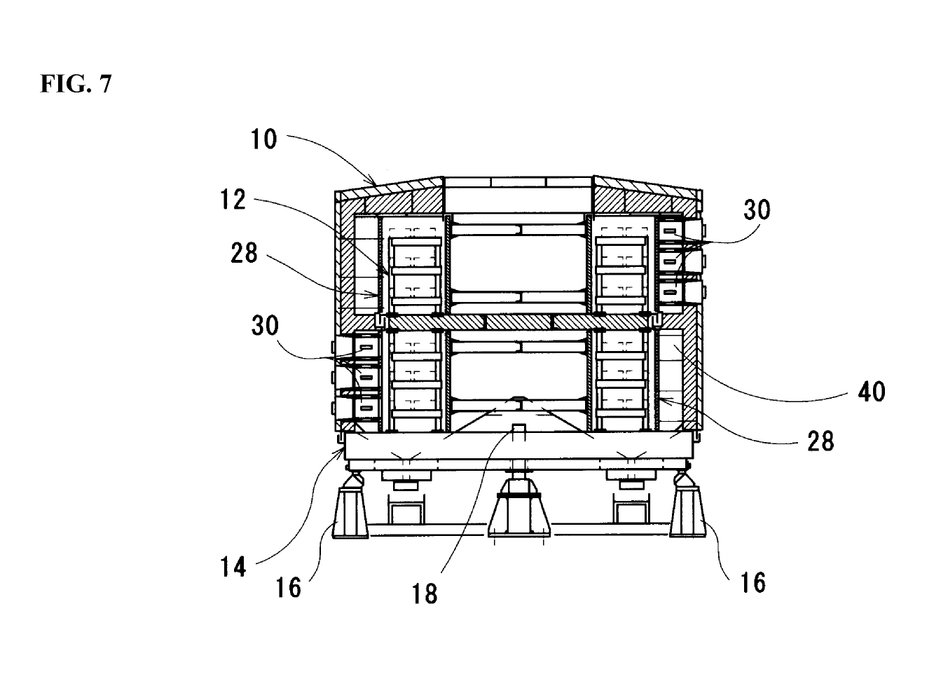

The heating furnace according to the present embodiment further includes inlet passage forming tubes 30 and outlet passage forming tubes 32. In the present embodiment, the inlet passage forming tubes 30 and the outlet passage forming tubes 32 are collectively referred to as “passage forming tubes”. The configuration of the inlet passage forming tubes 30 and the configuration of the outlet passage forming tubes 32 according to the present embodiment will be described with reference to FIGS. 6, 7, and 8. Each of the inlet passage forming tubes 30 is arranged between a furnace outside communication inlet portion 132 of the tubular partition 28 and an inlet opening of the furnace body 10 facing the furnace outside communication inlet portion 132. In this paragraph, “inlet opening” refers to the lower inlet opening 70 when the tubular partition 28 is arranged in the lower heat treatment chamber 46 and refers to the upper inlet openings 74 when the tubular partition 28 is arranged in the upper heat treatment chamber 48. Each of the inlet passage forming tubes 30 forms a passage. The workpiece 200 is placed on the workpiece loading unit 12 through the passage. The inlet passage forming tubes 30 are members which also reduce leakage of hot air from the furnace body 10. In the present embodiment, the inlet passage forming tubes 30 have a rectangular tubular shape. Each of the inlet passage forming tubes 30 has hot air guide holes 160. The hot air guide holes 160 are formed on three side surfaces of the inlet passage forming tube 30. Each of the outlet passage forming tubes 32 is arranged between a furnace outside communication outlet portion 134 of the tubular partition 28 and an outlet opening of the furnace body 10 facing the furnace outside communication outlet portion 134. In this paragraph, “outlet opening” refers to the lower outlet opening 72 when the tubular partition 28 is arranged in the lower heat treatment chamber 46 and refers to the upper outlet openings 76 when the tubular partition 28 is arranged in the upper heat treatment chamber 48. Each of the outlet passage forming tubes 32 forms a passage. The workpiece 200 is taken out of the workpiece loading unit 12 through the passage. The outlet passage forming tubes 32 are members which also reduce leakage of hot air from the furnace body 10. In the present embodiment, the outlet passage forming tubes 32 have a rectangular tubular shape. Each of the outlet passage forming tubes 32 also has hot air guide holes 160. The hot air guide holes 160 are formed on four side surfaces of the outlet passage forming tube 32.

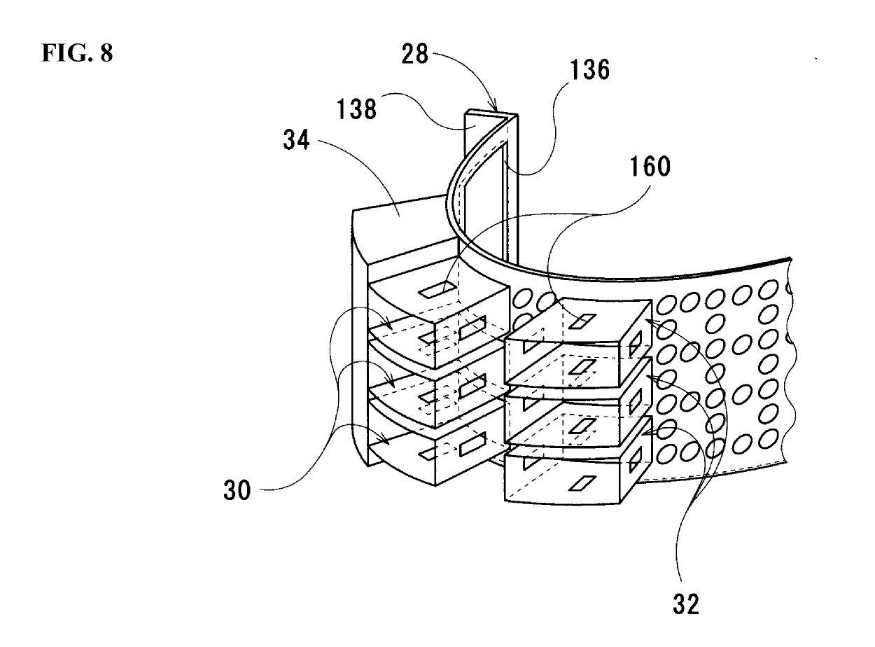

The heating furnace according to the present embodiment further includes a flow end wall 34. The configuration of the flow end wall 34 according to the present embodiment will be described with reference to FIGS. 4 and 8. The flow end wall 34 is arranged between the inner peripheral surface of the furnace chamber 40 and the tubular partition 28. The flow end wall 34 blocks hot air. In the present embodiment, the flow end wall 34 is arranged on the downstream side of the flow of hot air with respect to the furnace outside communication portions. In the lower heat treatment chamber 46, the flow end wall 34 is in contact with side surfaces of the inlet passage forming tubes 30, the side surfaces having no hot air guide hole 160.

### [Method of Using Heating Furnace]

A method of using the heating furnace according to the present embodiment based on the above configuration will be described.

An operator previously activates the lower hot air supply device 20, the lower heating device 22, the upper hot air supply device 24, and the upper heating device 26. Accordingly, the temperature inside the lower heat treatment chamber 46 becomes a temperature suitable for a solution treatment. Further, the temperature inside the upper heat treatment chamber 48 becomes a temperature suitable for an aging treatment. Then, an operator activates the hearth rotating unit 18. Accordingly, the hearth 14 starts rotating. The hearth 14 rotates in a counterclockwise direction when viewed from the upper side of the heating furnace according to the present embodiment. The workpiece loading unit 12 also rotates along with the rotation of the hearth 14.

Then, an operator opens the door of the lower inlet opening 70 and inserts the workpiece 200 into the lower heat treatment chamber 46 from the outside of the heating furnace using an appropriate jig. After the workpiece 200 is inserted, the door of the lower inlet opening 70 is closed. Since the workpiece loading unit 12 rotates, the workpiece 200 placed thereon also rotates.

Hot air is blown to the workpiece 200 placed on the workpiece loading unit 12 at a high speed. The workpiece 200 is rapidly heated by the hot air blown thereto. Hot air is blocked by the flow end wall 34, which increases the amount of hot air flowing into the inner space 110 from the outer space 112. Therefore, hot air is blown at a high speed. The increase in the amount of hot air results in an increase in the velocity of flow of hot air. Further, the increase in the velocity of flow of hot air results in an increase in the heat transfer coefficient. Further, the increase in the heat transfer coefficient results in an increase in the amount of heat transferred to the workpiece 200. Due to the increase in the amount of heat, the workpiece 200 is rapidly heated.

Since the lower hot air supply device 20 has been already operating, when the heated workpiece 200 reaches a position that faces the hot air inflow portion 140 of the tubular partition 28, the workpiece 200 is further heated by hot air flowing from the hot air inflow portion 140. Then, hot air flowing through the holes 158 of the hot air replenishment portion 142 is sequentially blown to the workpiece 200 which rotates inside the lower heat treatment chamber 46 along with the rotation of the workpiece loading unit 12. Sequentially blowing hot air maintains the temperature of the workpiece 200 constant while the workpiece 200 rotates inside the lower heat treatment chamber 46.

When the workpiece 200 placed on the workpiece loading unit 12 reaches a position that faces the corresponding lower outlet opening 72, an operator opens the door of the lower outlet opening 72 and takes the workpiece 200 out of the lower heat treatment chamber 46 to the outside of the heating furnace using an appropriate jig.

An operator performs a quenching treatment by a known method on the workpiece 200 taken out of the lower heat treatment chamber 46. An operator opens the door of the upper inlet opening 74 and inserts the workpiece 200 on which the quenching treatment has been performed into the upper heat treatment chamber 48 using an appropriate jig. After the workpiece 200 is inserted, the door of the upper inlet opening 74 is closed. Since the workpiece loading unit 12 rotates, the workpiece 200 placed thereon also rotates.

The workpiece 200 rotating in the upper heat treatment chamber 48 is heated in the same manner as when the solution treatment is performed on the workpiece 200 in the lower heat treatment chamber 46. However, the temperature inside the upper heat treatment chamber 48 is lower than the temperature inside the lower heat treatment chamber 46. Thus, a heat treatment applied to the workpiece 200 inside the upper heat treatment chamber 48 is an aging treatment.

When the workpiece 200 placed on the workpiece loading unit 12 reaches a position that faces the corresponding upper outlet opening 76, an operator opens the door of the upper outlet opening 76 and takes the workpiece 200 out of the upper heat treatment chamber 48 to the outside of the heating furnace using an appropriate jig.

### [Effect of Heating Furnace According to Present Embodiment]

With the heating furnace according to the present embodiment, it is possible to perform heat treatment within a single furnace in the above manner. In the heat treatment, even when hot air that has previously flown into the inner space 110 loses its thermal energy by heating the workpiece 200, hot air flowing into the inner space 110 thereafter compensates the lost thermal energy. Since the lost thermal energy is compensated, it is possible to reduce variation in temperature between various points inside the furnace chamber.

The hot air inflow portion 140 faces the furnace chamber communication portion. Thus, a part of the hot air that has flown into the furnace chamber 40 directly flows into the inner space 110. Accordingly, it is possible to reduce the loss of thermal energy caused by transfer of the thermal energy of hot air to the furnace body 10.

Further, hot air is prevented from flowing into the inner space 110 on the upstream side of the flow of hot air. Therefore, it is possible to prevent the temperature of the workpiece 200 from unnecessarily increasing.

Further, it is possible to reuse hot air that has flown out through the hot air outflow portion 136. Accordingly, it is possible to more efficiently use thermal energy for heating the workpiece 200 than when thermal energy is not reused.

Further, it is possible to prevent hot air fed into the furnace chamber 40 and hot air guided to the heating chamber from slowing their flow velocities each other. As a result, hot air smoothly flows.

Since the flow end wall 34 blocks hot air, the hot air flows into the inner space 110 before reaching the flow end wall 34. The hot air flowing into the inner space 110 makes the velocity of flow of hot air inside the inner space 110 higher than that when no hot air flows thereinto. The increase in the velocity of flow results in an increase in the heat transfer coefficient of hot air in a place where the velocity of flow increases. Further, the increase in the heat transfer coefficient accelerates a rise in the temperature of the workpiece 200.

When the passage forming tubes are arranged, it is possible to reduce the amount of hot air that flows through the outer space and then flows out of the furnace body 10 through the workpiece passing openings. The reduction in the amount of hot air makes it possible to reduce the loss of thermal energy caused by hot air flowing out of the furnace.

Further, the flow of hot air is guided to a rotation direction of the hearth 14. Thus, the hot air heats the workpiece 200 while flowing in the inner space. Accordingly, it is possible to efficiently transfer thermal energy to the workpiece 200 from hot air.

### [Description of Modifications]

The embodiment disclosed herein is an example in all points. The scope of the present invention is not limited to the above embodiment. It is needless to say that various modifications may be made without departing from the gist of the invention.

For example, a heat source, for example, an electric heater may be arranged as the lower heating device 22 or the upper heating device 26 instead of the combustion burner.

The tubular partition 28 may have slits instead of the holes 158. Not only the size of the holes 158 or slits, but also the number of holes 158 or slits per unit area may differ in the tubular partition 28. A specific structure of the furnace chamber inside communication portion 130 for allowing the inner space 110 and the outer space 112 to communicate with each other is not limited to the one descried above.

A specific form of the workpiece loading unit 12 is not particularly limited. The number of stages of the lower shelf 80 and the number of stages of the upper shelf 84 are not particularly limited. The number of doors attached to the lower inlet openings 70 and the lower outlet openings 72 is not particularly limited. For example, a large door may be attached in order to allow the workpieces 200 to be taken out and put in two stages of the workpiece loading unit 12. In this case, the number of doors is reduced.

The heat treatment chamber may be divided into three or more chambers. The heat treatment chamber may be a single chamber. The number of heat treatment chambers is preferably equal to the number of heating chambers, but may differ from the number of heating chambers. The furnace chamber 40 may not be divided into a heating chamber, a heat treatment chamber, and a portion allowing the heating chamber and the heat treatment chamber to communicate with each other. The role of each of the heat treatment chambers is not limited to the one described above. A part of each of the heat treatment chambers close to the hearth 14 may be used for an aging treatment. A part of each of the heat treatment chambers far from the hearth 14 may be used for a solution treatment. The hearting furnace according to the present invention may be used for heat treatment other than a solution treatment and an aging treatment. Examples of “heat treatment other than a solution treatment and an aging treatment” include an annealing treatment. The hearting furnace according to the present invention may be used for heating other than heat treatment. Examples of “heating other than heat treatment” include drying.

The hearth 14 may be rotated by a device other than the hearth rotating unit. The workpiece loading unit 12 may not include the lower direction guide body 86 and the upper direction guide body 88. The heating furnace may include no passage forming tube.

### DESCRIPTION OF REFERENCE SIGNS

10: Furnace body
12: Workpiece loading unit
14: Hearth
16: Hearth supporting unit
18: Hearth rotating unit
20: Lower hot air supply device
22: Lower heating device
24: Upper hot air supply device
26: Upper heating device
30: Inlet passage forming tube
32: Outlet passage forming tube
34: Flow end wall
40: Furnace chamber
46: Lower heat treatment chamber
48: Upper heat treatment chamber
50: Lower heating chamber
52: Upper heating chamber
54: Lower furnace chamber communication portion
56: Upper furnace chamber communication portion
62: Furnace body supporting leg
64, 68: Exhaust tube
66: Sand seal portion
70: Inlet opening
72: Outlet opening
80: Lower shelf
82: Partition plate
84: Upper shelf
86: Lower direction guide body
88: Upper direction guide body
90: Partition ring
100: Sand hopper
110: Inner space
112: Outer space
130: Furnace chamber inside communication portion
132: Furnace outside communication inlet portion
134: Furnace outside communication outlet portion
136: Hot air outflow portion
138: Hot air guide portion
140: Hot air inflow portion
142: Hot air replenishment portion
150: Upstream opening portion
152: Downstream opening portion
158: Hole
160: Hot air guide hole
200: Workpiece

1. A heating furnace comprising:
a furnace body that forms a furnace chamber and has a workpiece passing opening;
a workpiece loading unit arranged inside the furnace chamber;
a hearth that faces the furnace chamber, places the workpiece loading unit thereon, and rotates to allow the workpiece loading unit to rotate in the furnace chamber;
a hot air supply device that is arranged inside the furnace chamber and sends out hot air inside the furnace chamber; and
a tubular partition that is arranged inside the furnace chamber and divides the furnace chamber into an inner space in which the workpiece loading unit is arranged and an outer space in which the hot air supply device is arranged, the tubular partition including
a furnace chamber inside communication portion that allows the inner space and the outer space to communicate with each other, and
a furnace outside communication portion that allows the inner space and the workpiece passing opening to communicate with each other.

2. The heating furnace according to claim 1,
wherein the furnace chamber includes:
a heat treatment chamber in which the workpiece loading unit and the tubular partition are arranged,
a heating chamber in which the hot air supply device is arranged, and
a furnace chamber communication portion that allows the heating chamber and the heat treatment chamber to communicate with each other and allows the hot air to pass therethrough, and
wherein the furnace chamber inside communication portion of the tubular partition includes:
a hot air inflow portion that faces the furnace chamber communication portion and allows the inner space and the outer space to communicate with each other, and
a hot air replenishment portion that is arranged on a downstream side of flow of the hot air with respect to the hot air inflow portion and allows the inner space and the outer space to communicate with each other.

3. The heating furnace according to claim 2, wherein the hot air replenishment portion includes:
an upstream opening portion having a hole, the hole allowing the inner space and the outer space to communicate with each other, and
a downstream opening portion that is arranged on the downstream side of flow of the hot air with respect to the upstream opening portion, has a hole allowing the inner space and the outer space to communicate with each other, and has a larger opening area per unit area than the upstream opening portion.

4. The heating furnace according to claim 2,
wherein the tubular partition further includes a hot air outflow portion that is arranged on the downstream side of flow of the hot air with respect to the hot air replenishment portion, faces the furnace chamber communication portion together with the hot air inflow portion, and allows the hot air inside the inner space to flow out toward the furnace chamber communication portion therethrough, and
wherein the heating furnace further comprises a heating device that is arranged inside the heating chamber and heats the hot air that has flown out through the hot air outflow portion and flown into the heating chamber.

5. The heating furnace according to claim 4, wherein the tubular partition further includes a hot air guide portion that guides the hot air fed into the heat treatment chamber from the heating chamber to the hot air inflow portion and guides the hot air flowing out through the hot air outflow portion to the heating chamber.

6. The heating furnace according to claim 1, further comprising a flow end wall that is arranged between an inner peripheral surface of the furnace chamber and the tubular partition and blocks the hot air.

7. The heating furnace according to claim 6,
wherein the flow end wall is arranged on a downstream side of flow of the hot air with respect to the furnace outside communication portion, and
wherein the workpiece loading unit rotates in a direction of the flow of the hot air.

8. The heating furnace according to claim 1, further comprising a passage forming tube arranged between the furnace outside communication portion and the workpiece passing opening to form a passage.

9. The heating furnace according to claim 1, wherein the workpiece loading unit includes:
a shelf, and
a direction guide body that is arranged at the position nearer a rotation center of the hearth than the shelf and guides flow of the hot air in the inner space to a rotation direction of the hearth.
